(19) United States
(12) Patent Application Publication
(10) Pub. No.: US 2004/0147143 A1
(43) Pub. Date: Jul. 29, 2004

(54) Micro-storage device capable of being conjoined with a personal adornment

(75) Inventors: Gordon Yu, Taipei (TW); Forli Wen, Hsinchu (TW); Justin Cheng, Taichung (TW); Tsung-Kan Cheng, Taipei (TW)

Correspondence Address: BACON & THOMAS, PLLC, 625 SLATERS LANE, FOURTH FLOOR, ALEXANDRIA, VA, 22314

(73) Assignees: C-One Technology Corporation, Hsin-Chu City (TW); Pretec Electronics Corporation, Fremont, CA (US)

(21) Appl. No.: 10/639,461

(22) Filed: Aug. 13, 2003

(30) Foreign Application Priority Data
Jan. 27, 2003 (TW) 92201457

(51) Int. Cl. H01R 12/00

(52) U.S. Cl. 439/76.1

(57) ABSTRACT

A micro-storage device capable of being conjoined with a personal adornment is disclosed, which has a connector formed by an extension to a circuit board and accordingly forms an all-in-one substrate. Electronics are packaged on the substrate by a chip package technique to house the electronics and corresponding circuitry on the substrate by a metal case to offer a product protection function. The inventive micro-storage device can conjoin with a personal adornment for portability.

### BACKGROUND OF THE INVENTION

1. Field of the Invention

The present invention relates to a micro-storage device and, more particularly, to a micro-storage device capable of being conjoined with a personal adornment.

2. Description of Related Art

With the advance of information industry, information products are getting popular. Currently, most information products process data in a digital form and store the data in a storage medium. However, the increasing complexity of operation processes of the information products makes the size of digital data become larger, and accordingly the capacity of a typical disk becomes insufficient. Therefore, a flash disk for storing data using a flash memory has been developed to solve the insufficient capacity of a portable storage medium.

The current flash disk has a substrate soldered with a plurality of electronic components and a flash memory for providing a data storage capacity. The flash disk is small in compared with other storage media, however, under the present intense demand for devices that are smaller, thinner, lighter and so on, it is desired to further miniaturize the flash disk and increase the portable convenience. Unfortunately, it is difficult to achieve such a purpose because a height generated between the electronic components and the substrate by soldering points needs an appropriate thickness of a case for housing the substrate and the electronics. Therefore, it is desirable to provide an improved portable storage device to mitigate and/or obviate the aforementioned problems.

### SUMMARY OF THE INVENTION

The object of the present invention is to provide a micro-storage device capable of being conjoined with a personal adornment, which provides a very small, thin, light memory for storage, to conjoin with a personal adornment, so as to be conveniently carried by a user.

To achieve the object, the inventive micro-storage device capable of being conjoined with a personal adornment includes: a substrate having a circuit board and a connector extended from the circuit board, wherein the connector is arranged with a plurality of contacts for electrically connecting to an external electronic apparatus; at least one electronic component mounted on a surface of the circuit board by an advance package technique; and a metal case housing the substrate and the electronic component and having an opening at the connector for coupling to the external electronic apparatus.

Other objects, advantages, and novel features of the invention will become more apparent from the following detailed description when taken in conjunction with the accompanying drawings.

### BRIEF DESCRIPTION OF THE DRAWINGS

FIG. 1 is an exploded diagram of a preferred embodiment in accordance with the invention;

FIG. 2a and FIG. 2b are schematic diagram of configurations of the preferred embodiment in accordance with the invention;

FIG. 3 is a first schematic diagram of the preferred embodiment conjoined with a personal adornment; and

FIG. 4 is a second schematic diagram of the preferred embodiment conjoined with another personal adornment.

### DETAILED DESCRIPTION OF THE PREFERRED EMBODIMENT

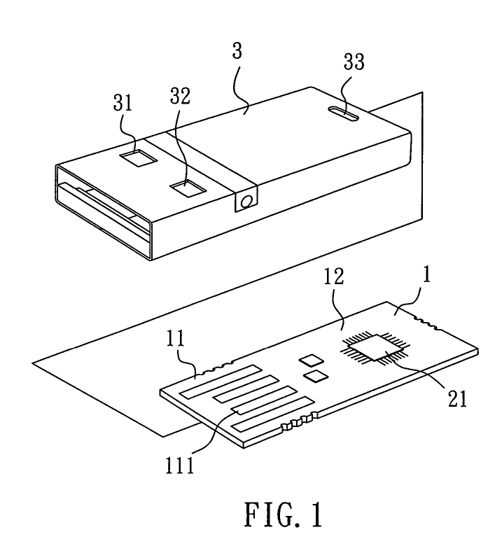

With reference to FIG. 1, there is shown a micro-storage device having a substrate 1 and a metal case 3. The substrate 1 has a circuit board 12 and a connector 11 extended from the circuit board 12. A plurality of contacts 111 is arranged on the connector 11, i.e., the contacts are formed directly onto the substrate 1 by layout to electrically connect to an external electronic apparatus (not shown). The circuit board 12 is mounted with at least one electronic component 21 by an advance package technique.

The advance package technique is a Chip On Board (COB) or Surface Mount Technology (SMT), for example. The COB uses UV glue to adhere a chip and package the electronic component 21 onto the circuit board 12 by wire bonding such that the electronic component 21 is closely mounted on and almost at the same level of the circuit board 12. As such, the circuit board 12 and the electronic component 21 combined together contributes to a relatively small thickness. Furthermore, the above contacts 111 have almost no additional height due to the direct layout on the substrate 1 and thus the entire storage device can have small, thin, light and the like features.

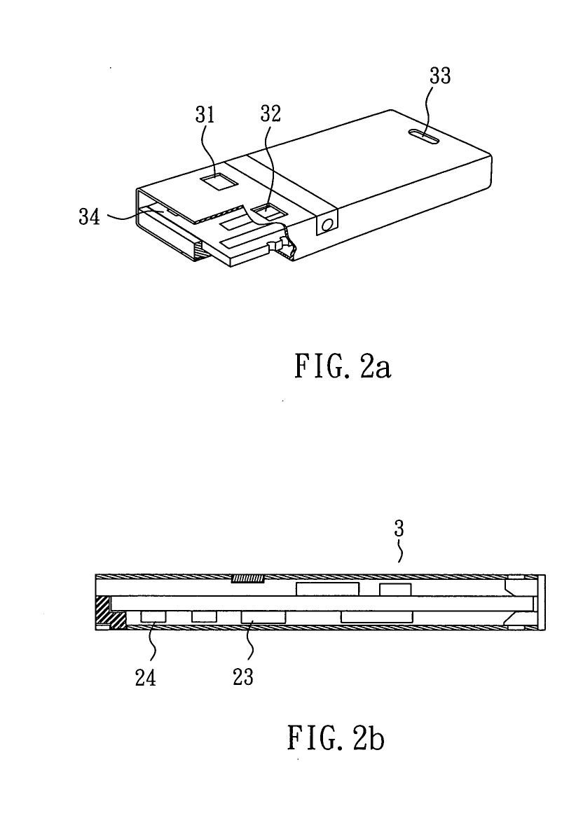

Additionally, the required circuitry is formed by layout between the contacts and electronic component 21 on the substrate 1, such that the external electronic apparatus can access or operate the electronic component 21 on the substrate 1. The electronic component 21 is a non-volatile memory such as a flash memory (NAND type flash memory) to store data. The metal case 3 houses the entire substrate 1 including the contacts 111 and the electronic component 21 to offer protection thereto. The metal case 3 has a plurality of holes 31, 32, 33 and an opening 34 (with reference to FIG. 2a). The holes 31 and 32 are located on an upper portion of the connector 11 while the hole 33 is located on an upper portion of the circuit board 12 for use as a hook hole or a lock to fix on a personal adornment. The opening 34 is located at the connector 11 to connect to the external electronic apparatus. The holes 31 and 32 can lock the metal case 3 to the external electronic apparatus.

FIG. 2b is a lateral view of the present invention. In FIG. 2b, the electronic component 23 is mounted on the back of the circuit board 12, and the electronic component 24 is especially opposite to the connector 11 to effectively use the space between the metal case 3 and the substrate 1.

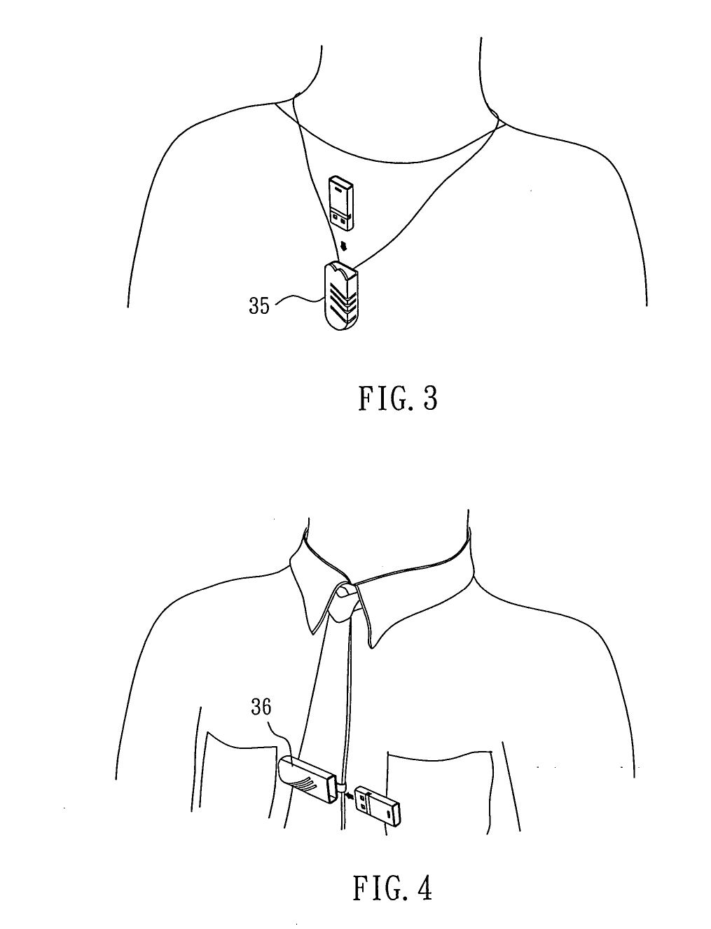

FIG. 3 is a first schematic diagram of the preferred embodiment conjoint with a personal adornment. The metal case 3 is still thin because a fine package technique is applied to package the electronic component. Accordingly, the inventive device can be inserted into a necklace 35. The necklace 35 has a hollow portion to receive the inventive micro-storage device. The necklace 35 can be designed to have a desired shape. FIG. 4 is a second schematic diagram of the preferred embodiment conjoint with another personal adornment, wherein the personal adornment is a tie clip 36 for being applied to conjoin with the inventive micro-storage device. In addition to the necklace and tie clip, the inventive micro-storage device can be arranged in any kind of suitable personal adornments.

Although the present invention has been explained in relation to its preferred embodiment, it is to be understood that many other possible modifications and variations can be made without departing from the spirit and scope of the invention as hereinafter claimed.

What is claimed is:

1. A micro-storage device capable of being conjoined with a personal adornment, comprising:
a substrate having a circuit board and a connector extended from the circuit board, wherein the connector is arranged with a plurality of contacts for electrically connecting to an external electronic apparatus;
at least one electronic component mounted on a surface of the circuit board using an advance package technique; and
a metal case housing the substrate and the electronic component and having an opening at the connector for coupling to the external electronic apparatus.

2. The micro-storage device as claimed in claim 1, further comprising a small hollow object for being inserted with the micro-storage device thereby conveniently carrying the micro-storage device.

3. The micro-storage device as claimed in claim 2, wherein the small hollow object is a personal adornment.

4. The micro-storage device as claimed in claim 3, wherein the personal adornment is a necklace.

5. The micro-storage device as claimed in claim 3, wherein the personal adornment is a tie clip.

6. The micro-storage device as claimed in claim 1, wherein the advance package technique is a Chip On Board (COB) or Surface Mount Technology (SMT).

7. The micro-storage device as claimed in claim 1, wherein the electronic component comprises a non-volatile memory to store data.

8. The micro-storage device as claimed in claim 1, further comprising electronic components mounted on an opposite of the connector in the substrate to effectively utilize space.
